(19) United States
(12) Patent Application Publication
(10) Pub. No.: US 2026/0356174 A1
(43) Pub. Date: Nov. 12, 2026

(54) VEHICULAR REAR SLIDER WINDOW WITH TWO-PIECE UPPER RAIL

(71) Applicant: Magna Exteriors Inc., Troy, MI (US)

(72) Inventors: David K. Johnson, Holland, MI (US); Kyle S. Bowman, Holland, MI (US)

(21) Appl. No.: 19/661,932

(22) Filed: Apr. 29, 2026

Related U.S. Application Data
(60) Provisional application No. 63/801,205, filed on May 7, 2025.

(51) Int. Cl. B60J 1/18; B60J 1/00

(52) U.S. Cl. CPC B60J 1/1853; B60J 1/006

(57) ABSTRACT

A vehicular rear slider window assembly includes a fixed window panel, a movable window panel, and upper and lower rails attached to the fixed window panel. The movable window panel is movable along the upper and lower rails. The upper rail includes a base portion attached to the fixed window panel and having a first engaging element and a cover portion attached to the base portion and having a second engaging element. With the second engaging element engaged with the first engaging element, the cover portion is at least partially secured relative to the base panel and the fixed window panel. An attachment element is disposed at the upper rail to further secure the cover portion relative to the base portion. A channel of the upper rail is disposed between the base portion and the cover portion and receives an upper perimeter edge portion of the movable window panel.

### CROSS REFERENCE TO RELATED APPLICATION

The present application claims the filing benefits of U.S. provisional application Ser. No. 63/801,205, filed May 7, 2025, which is hereby incorporated herein by reference in its entirety.

### FIELD OF THE INVENTION

The present invention relates generally to movable or slider window assemblies for vehicles and, more particularly to a side or rear slider window assembly for a vehicle such as a pickup truck or the like.

### BACKGROUND OF THE INVENTION

It is known to provide a slider window assembly for an opening of a vehicle, such as a rear slider window assembly for a rear opening of a pickup truck. Conventional slider window assemblies for rear openings of trucks or the like typically include three or more panels, such as two fixed window panels and a slidable window panel. The slidable window panel is supported by rails and may be moved along the rails to open and close the window. The slidable window panel may be driven or moved by a cable drive system.

### SUMMARY OF THE INVENTION

A vehicular rear window assembly, such as a vehicular rear slider window assembly or a vehicular rear fixed window assembly, includes a fixed window panel having an inner side and an outer side. The vehicular rear window assembly may be configured for mounting at a rear portion of a cabin of a vehicle, such as a pickup truck. With the vehicular rear window assembly mounted at the rear portion of the interior cabin of the vehicle, the inner side faces toward the interior cabin of the vehicle and the outer side faces exterior of the vehicle. An upper rail and a lower rail are attached to the fixed window panel. A movable window panel is movable along the upper rail and the lower rail between (i) a closed position where the movable window panel is disposed at an opening of the fixed window panel and (ii) an opened position where the movable window panel is disposed at least partially along the fixed window panel. The upper rail includes a base portion attached to the fixed window panel and having a first engagement element and a cover portion attached to the base portion and having a second engagement element. With the second engaging element of the cover portion engaged with the first engaging element of the base portion, the cover portion is at least partially secured relative to the base portion and the fixed window panel. With the cover portion at least partially secured relative to the base portion and the fixed window panel, an attachment element is disposed at the upper rail to attach the cover portion to the base portion. A channel of the upper rail is disposed between the base portion and the cover portion of the upper rail. The channel receives an upper perimeter edge portion of the movable window panel.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear slider window assembly;

FIG. 2 is a perspective view of the rear slider window assembly;

FIG. 3 is a perspective view of an upper rail of the rear slider window assembly;

FIG. 4 is an exploded view of the upper rail;

FIG. 5 is a partial view of the vehicular rear slider window assembly;

FIG. 5A is a sectional view along line A-A of FIG. 5;

FIG. 5B is a sectional view along line B-B of FIG. 5;

FIG. 5C is a sectional view along line C-C of FIG. 5;

FIG. 6 is a plan view of another rear slider window assembly;

FIG. 6A is a sectional view along line A-A of FIG. 6;

FIG. 6B is a sectional view along line B-B of FIG. 6;

FIG. 6C is a sectional view along line C-C of FIG. 6;

FIGS. 7 and 8 are views of a base portion of an upper rail of the rear slider window assembly of FIG. 6;

FIG. 9 is a perspective view of a cover portion of the upper rail of the rear slider window assembly of FIG. 6;

FIGS. 10-12 are views of the upper rail of the rear slider window assembly of FIG. 6; and

FIG. 13 is an exploded view of the upper rail of the rear slider window assembly of FIG. 6.

### DESCRIPTION OF THE PREFERRED EMBODIMENTS

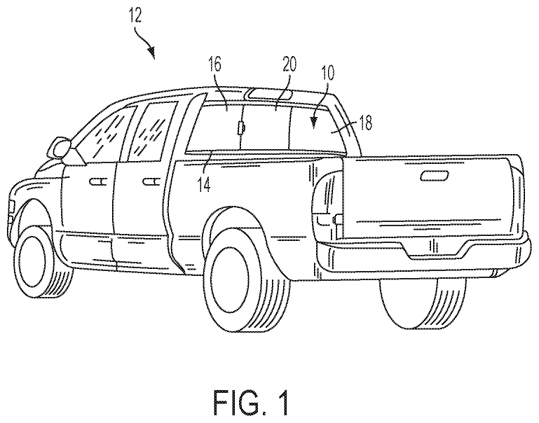

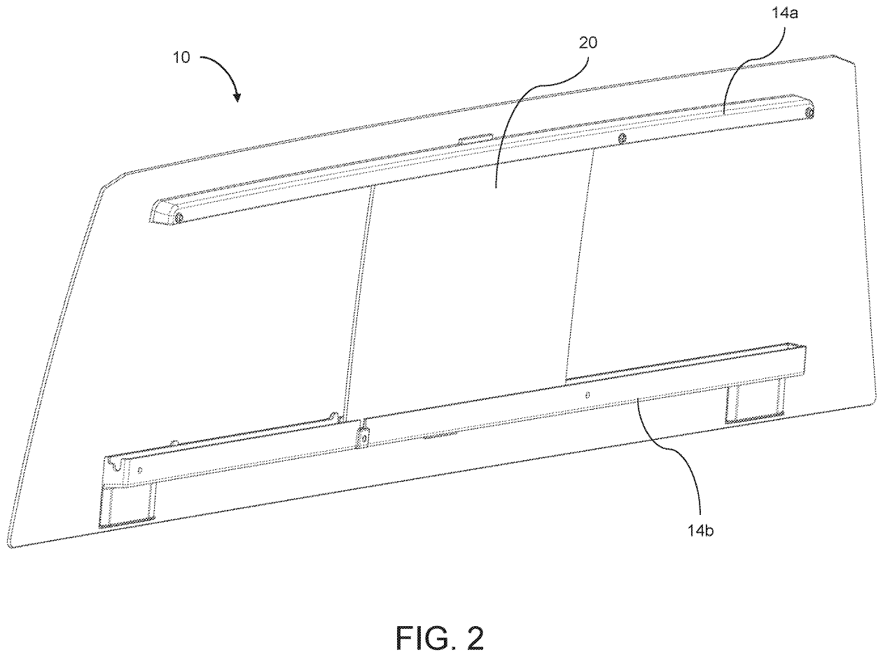

Referring now to the drawings and the illustrative embodiments depicted therein, a rear slider window assembly 10 of a vehicle 12 (such as a pickup truck or the like) includes a window frame 14 (having an upper rail 14a and a lower rail 14b), a pair of side fixed window panels 16, 18 and a movable window panel 20 that is movable relative to the frame 14 and the fixed window panels 16, 18 between an opened position and a closed position (FIGS. 1 and 2). The fixed window panels 16, 18 may be spaced from one another to define an opening or aperture between the fixed window panels 16, 18. The fixed window panels may comprise two separate spaced apart fixed window panels that define the opening 18 therebetween (and with upper and lower appliques or trim or filler panels or elements disposed at the upper and lower regions of the opening 18 and between the fixed window panels, and optionally with the upper rail 14a disposed at or within the upper appliqué and the lower rail 14b disposed at or within the lower applique). Optionally, the window assembly may comprise a hole-in-glass window configuration, where a single fixed glass panel has the aperture or hole or opening established therethrough to define separate spaced apart fixed window panels or panel portions, such as in a similar manner as the window assemblies described in U.S. Pat. No. 8,881,458, which is hereby incorporated herein by reference in its entirety. In the closed position, the movable window panel 20 is disposed at the opening between the fixed window panels 16, 18 (or at the opening between the sides or portions of the singular fixed window panel). In the opened position, the movable window panel 20 is disposed at least partially along one of the fixed window panels 16, 18 (or along one side or portion of the singular fixed window panel).

The frame 14 includes the upper rail 14a and the lower rail 14b, with the upper and lower edge regions of the movable window panel 20 movably or slidably received in and along the respective upper and lower rails. The slider or movable window panel 20 is movable along the lower rail 14b and upper rail 14a of the frame portion 14 to open and close the aperture or opening 18. For example, the slider window panel 20 may be disposed at a lower carrier, which may receive the lower perimeter edge region of the slider window panel 20 therein and may be slidably or movably received in the channel portion of the lower rail 14b of the frame portion 14.

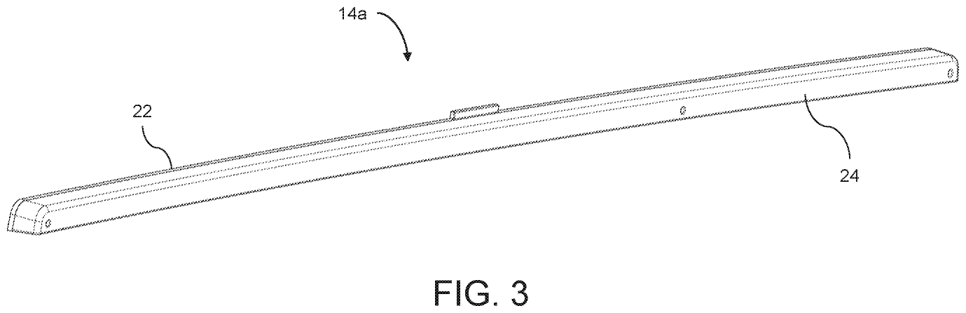

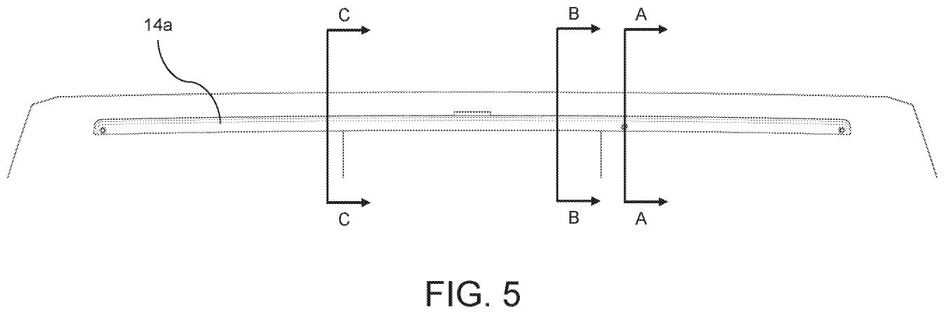

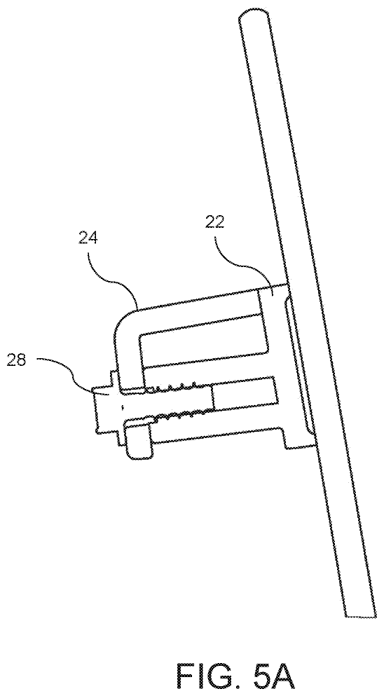

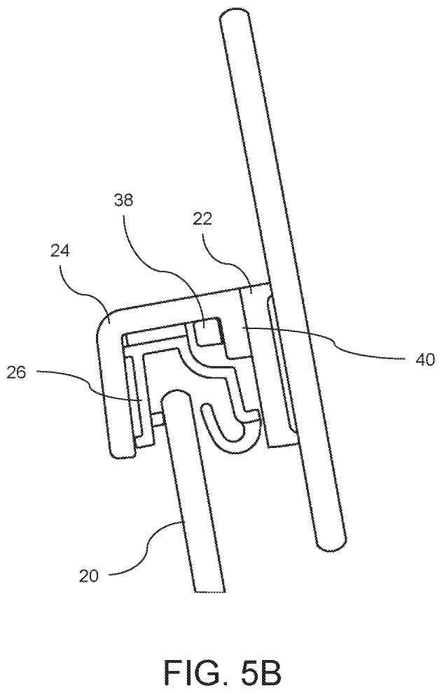

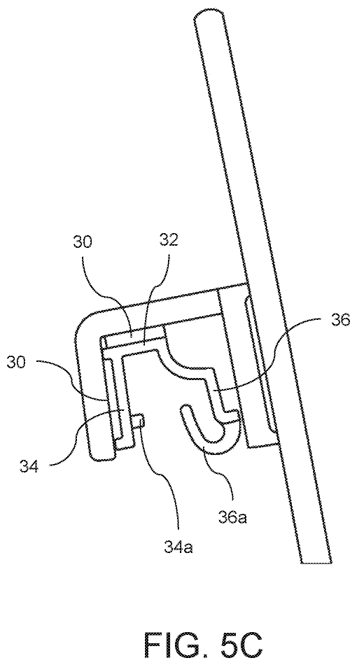

Referring to FIGS. 2-5C, the upper rail 14a may include a two-piece upper rail where the upper rail 14a includes a base portion 22 that attaches to a surface of the fixed window panel or panels (e.g., to an in-cabin or interior surface of the window panel or panels), such as via adhesive attachment to the surface of the fixed window panels 16, 18. The upper rail 14a further includes a cover portion 24 that attaches to the base portion 22, such as via snap attachment, adhesive, and/or one or more threaded fasteners 28 (e.g., screws, bolts, and the like) (FIG. 5A). A channel, such as a U-shaped channel, is formed between the cover portion 24 and the base portion 22 for receiving the upper perimeter edge portion of the movable window panel 20.

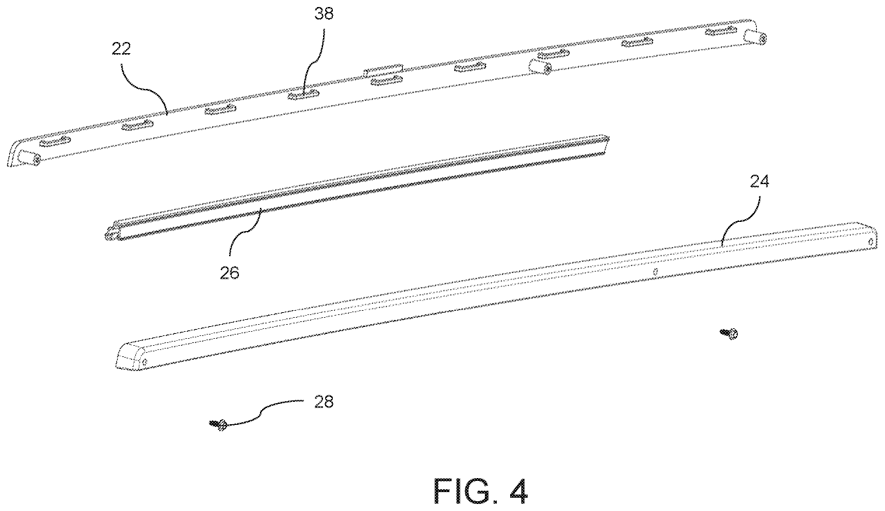

As shown in FIGS. 4, 5B, and 5C, a filler element 26 is disposed within the channel of the upper rail 14a for receiving the upper perimeter edge portion of the movable window panel 20. For example, the filler element 26 may comprise a flexible or compressible material, such as a rubber or other polymeric material, configured to receive the movable window panel 20 and at least partially flex or compress between the movable window panel and the upper rail 14a to attenuate vibrations from transferring between the upper rail 14a and the movable window panel 20 as the vehicle 12 travels along the road and/or the movable window panel 20 is moved between the opened and closed positions. The filler element 26 may comprise a substantially U-shaped filler element that defines a corresponding channel for receiving the upper perimeter edge portion of the movable window panel 20 within the channel of the upper rail 14a. Optionally, the filler element 26 includes one or more separate and distinct lengths of flexible material disposed within the channel of the upper rail 14a and configured to provide cushioning or a flexible barrier between the upper perimeter edge portion of the movable window panel 20 and interior surfaces of the upper rail 14a. For example, the filler element 26 may include one or more of (i) a first lip or compressible portion disposed along a first interior side wall of the U-shaped channel of the upper rail 14a, (ii) a second lip or compressible portion disposed along an opposing second interior side wall of the U-shaped channel of the upper rail 14a, and (iii) a base portion disposed along the base wall or surface extending between the first and second interior side walls of the U-shaped channel of the upper rail 14a.

The filler element 26 is attached to at least a portion of the upper rail 14a so that the movable window panel 20 moves at least partially within and relative to the filler element 26 when moved between the opened and closed positions. In the illustrated example, the filler element 26 is attached to the cover portion 24 of the upper rail 14a via an adhesive element 30 (e.g., an adhesive tape) disposed between a base portion or upper surface of the U-shaped channel and a base portion 32 of the filler element 26 (FIG. 5C).

As shown in FIG. 5C, the filler element 26 may comprise a substantially U-shaped structure with a first leg 34 extending from the base portion 32 and along a first side or surface of the U-shaped channel of the upper rail 14a. A second adhesive element 30 may be disposed between the first leg 34 and the surface of the channel. A second leg 36 of the filler element 26 may extend along an opposing second side or surface of the U-shaped channel of the upper rail 14a. A biasing element or surface 34a may extend from the first leg 34 for engaging a first side of the movable window panel 20 and another biasing element or surface 36a may extend from the second leg 36 for engaging an opposing second side of the movable window panel 20. In the illustrated example, the biasing element 34a of the first leg 34 comprises a protrusion of compressible material and the biasing element 36a of the second leg 36 comprises a flexible arm or fin. Thus, with the movable window panel 20 disposed within the U-shaped channel and received by the filler element 26, the movable window panel 20 is disposed between the first leg 34 and the second leg 36 with the biasing elements 34a, 36b at least partially flexed or compressed between the movable window panel 20 and the upper rail 14a to attenuate vibrations and/or maintain a position of the movable window panel 20 between the closed position and the opened position. The filler element 26 may extend within the U-shaped channel at least along the range of motion of the movable window panel 20 between the closed position and the opened position.

As shown in FIGS. 4 and 5B, the base portion 22 includes a plurality of catches or receiving portions 38 that extend from the base portion 22 and that are configured to receive corresponding protrusions or hooks 40 of the cover portion 24. With the hooks 40 received by corresponding catches 38, the cover portion 24 may be at least partially secured to the base portion 22, such as for holding the cover portion 24 at the base portion 22 while the movable window panel 20 is disposed within the channel and/or the threaded fasteners 28 are installed to further secure the cover portion 24 at the base portion 22.

For example, when installing the upper rail 14a at the window assembly 10, the filler element 26 is attached to the cover portion 24 prior to attaching the cover portion 24 at the window assembly. Thus, the base portion 22 is attached to the fixed window panels 16, 18 and, with the filler element 26 attached to the cover portion 24, the cover portion 24 is at least partially secured relative to the base portion 22 (e.g., via the hooks 40 and catches 38). The upper perimeter edge portion of the movable window panel 20 may then be inserted into the channel of the lower rail 14b and the filler element 26 at the channel of the upper rail 14a. For example, with the hooks 40 received in the catches 38, the cover portion 24 may be at least partially movable or pivotable relative to the base portion 22 to accommodate the upper perimeter edge portion of the movable window panel 20 being inserted into the channel. The threaded fasteners 28 may then be installed to further secure the cover portion 24 to the base portion 22 and retain the movable panel 20 within the channel of the upper rail 14a. In some examples, the movable window panel 20 may be disposed in the channel of the upper rail 14a after the cover portion 24 is secured to the base portion 22 via the threaded fasteners 28.

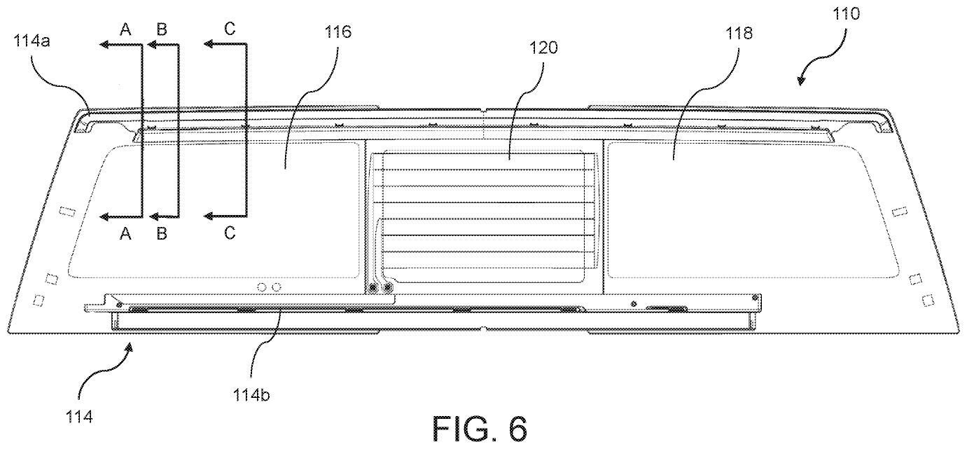

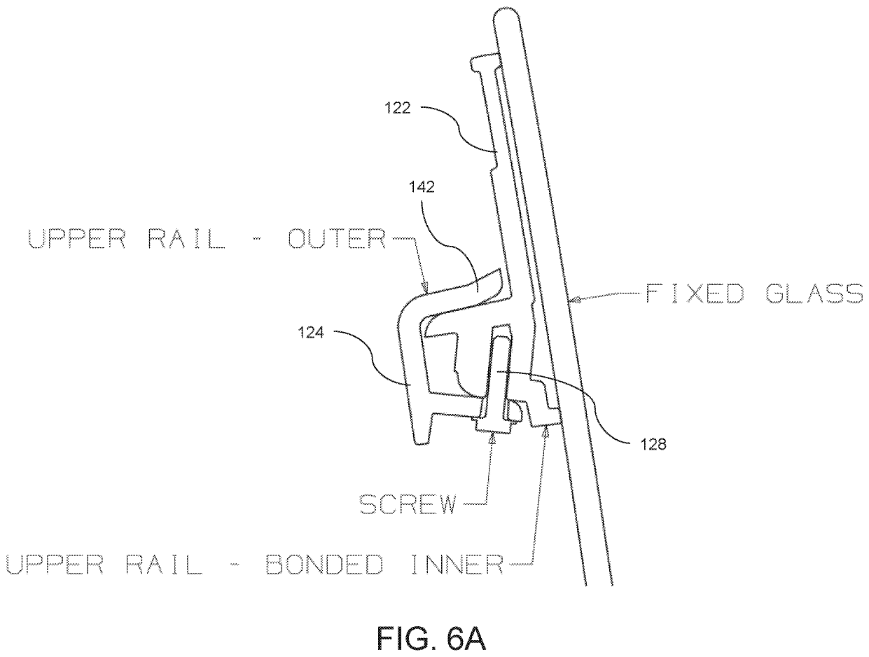

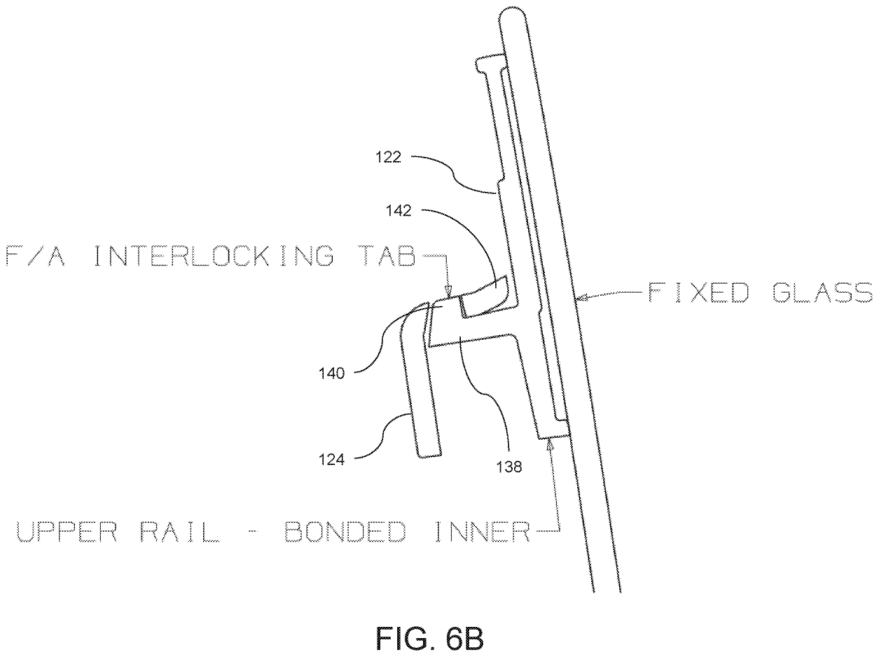

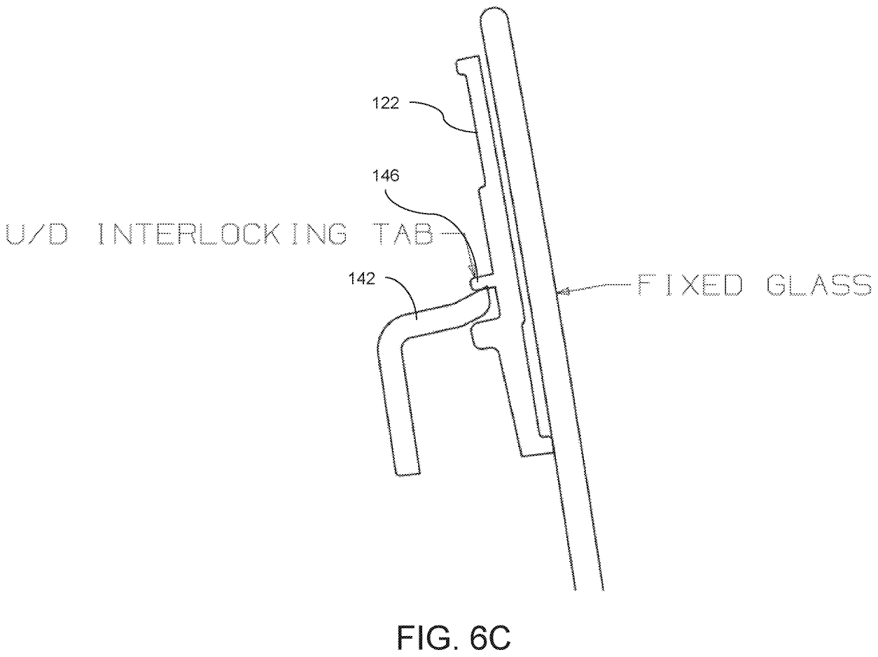

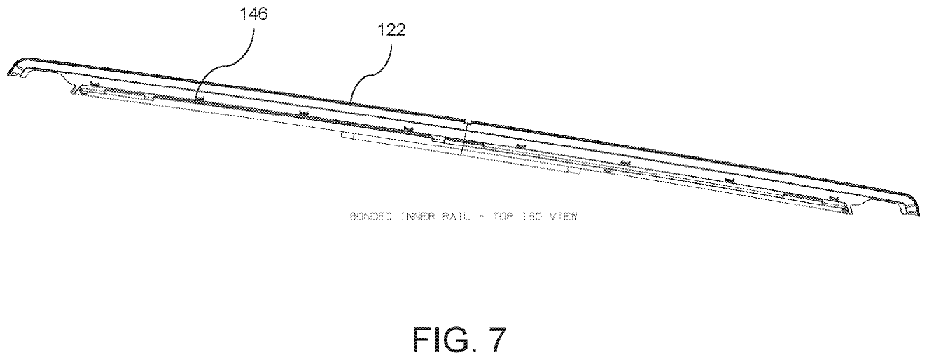

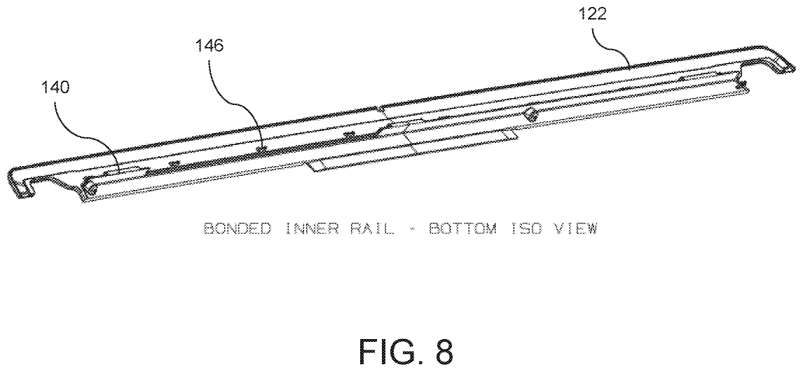

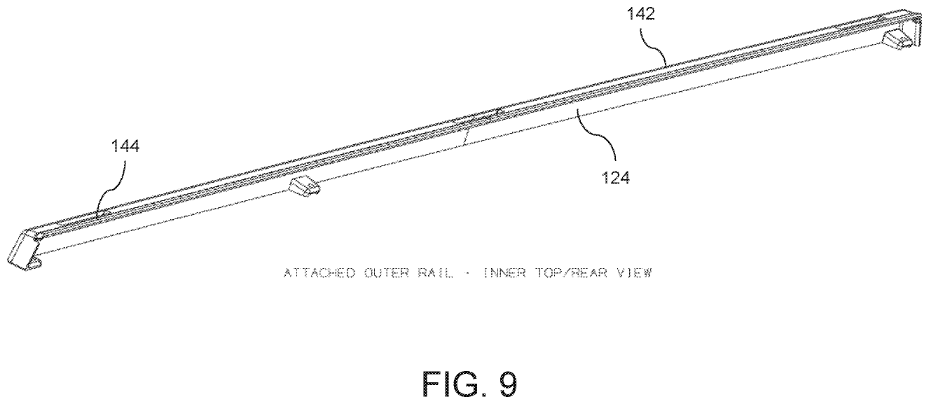

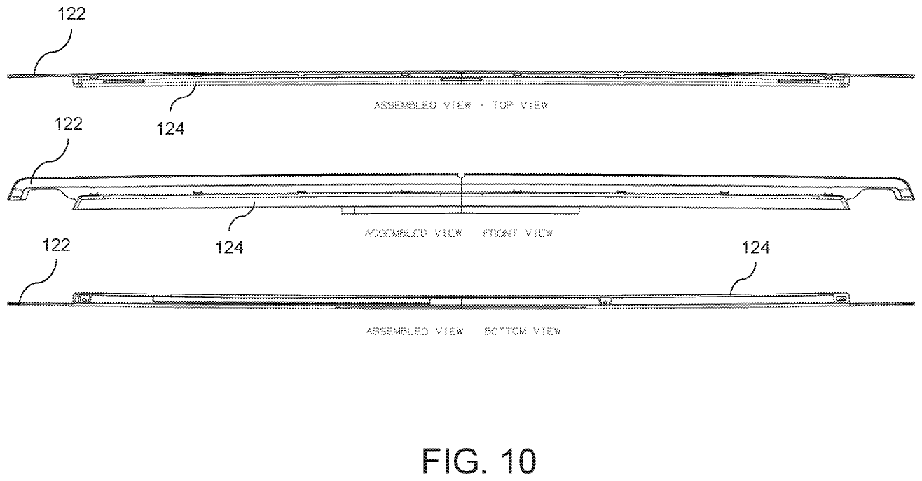

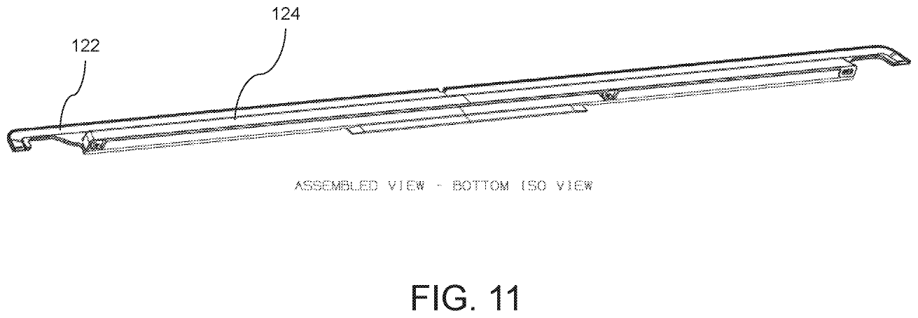

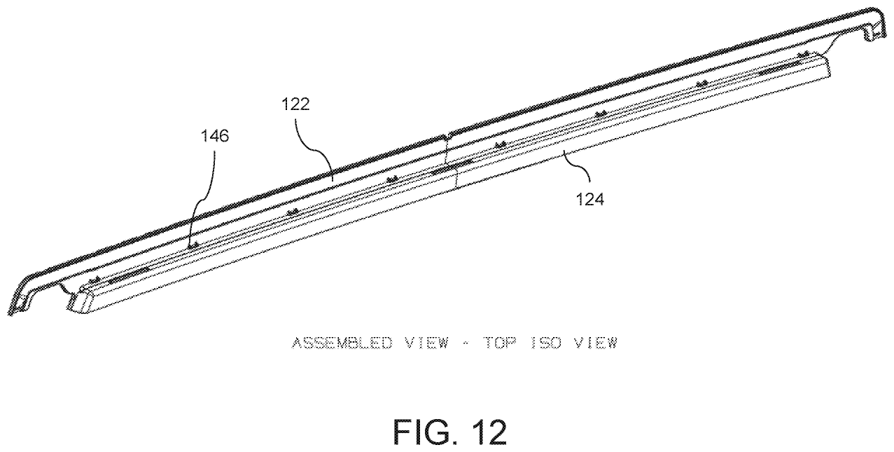

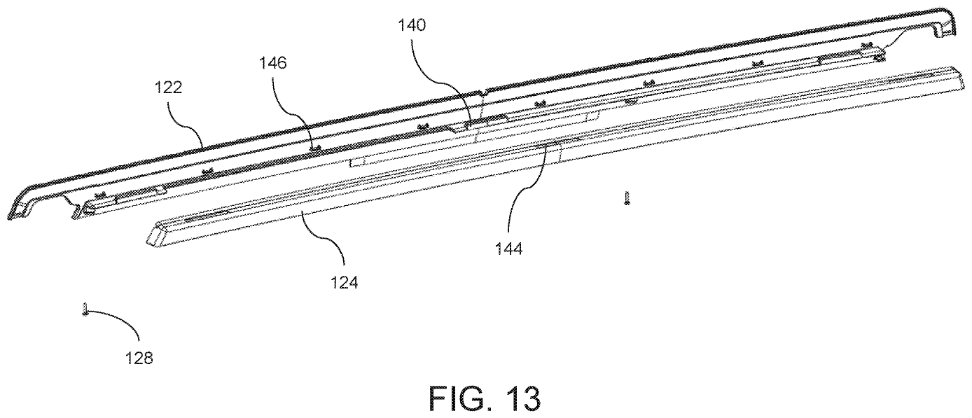

Optionally, the cover portion of the upper rail may receive one or more tabs of the base portion, such as to temporarily or at least partially secure the cover portion to the base portion that is adhered to the fixed window panels, and one or more threaded fasteners may further secure the cover portion to the base portion. For example, and such as shown in FIGS. 6-13, a window assembly 110 includes a frame assembly 114 having an upper rail 114a and a lower rail 114b attached to fixed window panels 116, 118 of the window assembly 110. A movable window panel 120 is movable disposed within a channel of the lower rail 114b and a channel of the upper rail 114a. The upper rail 114a includes a base portion 122 that adhesively attaches to the fixed window panels 116, 118 and a cover portion 124 that attaches to the base portion 122 to form the channel configured to receive the movable window panel 120. The upper rail 114a may also include a filler element configured to receive the upper perimeter edge portion of the movable window panel 120 within the U-shaped channel of the upper rail 114a, such as according to aspects described herein.

The base portion 122 includes an upper flange or leg 138 that extends away from the fixed window panels 116, 118 (and that may form at least a portion of the upper surface of the U-shaped channel) and that includes one or more tabs or protrusions 140 extending from an upper surface of the upper leg 138 (FIG. 6B). The cover portion 124 includes an upper flange or leg 142 that, when the cover portion 124 is attached to the base portion 122, extends at least partially over and along the upper leg 138 of the base portion 122. Apertures or receiving portions 144 may be formed at the upper flange 142 of the cover portion 124 and configured to receive the protrusions 140 of the upper leg 138 of the base portion 122. For example, the cover portion 124 may snap attach to the base portion 122 when the protrusions 140 are received within the receiving portions 144. Moreover, the base portion 122 includes a plurality of hooks or catches or tabs 146 that extend at least partially over the upper leg 138 so that and end of the upper flange 142 of the cover portion 124 is received between the hooks 146 and upper leg 138 (FIG. 6C). The end of the upper flange 142 may be curved or angled at least partially upward to engage the hooks 146. This prevents the cover portion 124 from pulling out of engagement with the base portion 122. For example, the ends of the upper flange 142 engaging the hooks 146 may prevent the upper flange 142 from flexing away from the upper leg 138 and thus releasing the protrusions 140. Thus, with the protrusions 140 received by the receiving portions 144 and the end of the upper flange 142 engaged with the hooks 146, the cover portion 124 may attach to the base portion 122 and be at least temporarily or partially secured at the base portion 122.

When installing the upper rail 114a at the window assembly 110, the base portion 122 may be attached (e.g., adhesively attached) to the fixed window panels 116, 118 and the cover portion 124 may be attached to the base portion 122 by aligning the protrusions 140 of the upper leg 138 of the base portion 122 with the receiving portions 144 of the cover portion 124. As the protrusions 140 are received within the receiving portions 144, the end of the upper flange 142 of the cover portion 124 may hook or engage underneath the hooks 146 of the base portion 122. Threaded fasteners 128, such as screws or bolts, may then further attach or secure the cover portion 124 at the base portion 122 (FIG. 6A). As shown, the threaded fasteners 128 may be disposed outside the range of motion of the movable window panel 120 and be inserted upward from below the upper rail 114a to secure the cover portion 124 to the base portion 122, such that an overhang or lip of the cover portion 124 may at least partially hide the threaded fasteners 128 from view when installed.

The window panel may comprise a glass window panel, such as transparent tempered glass window panel or the like. Optionally, the window panel may comprise a non-glass material, such as a transparent or substantially transparent plastic or polymeric or acrylic material or the like.

The movable or slider window panel may be movable such as via manual pushing or pulling at the window panel or in response to actuation of a drive motor of a drive motor assembly or system, which may move cables or the like to impart horizontal movement of the slider window panel along the rails. Optionally, the window assembly or assemblies and drive system may utilize aspects of the window assemblies and drive systems described in U.S. Pat. Nos. 11,331,984; 10,501,977; 8,938,914; 8,915,018; 8,881,458; 8,402,695; 7,073,293; 7,003,916; 6,955,009; 6,691,464; 6,119,401; 5,799,444; 5,572,376; 5,531,046; 5,146,712; 4,995,195 and/or 4,920,698, and/or U.S. Publication Nos. US-2025-0026184; US-2021-0355737; US-2019-0383084; US-2014-0047772; US-2008-0127563; US-2006-0107600; US-2004-0020131 and/or US-2003-0213179, all of which are hereby incorporated herein by reference in their entireties.

Optionally, the window assembly or assemblies may utilize aspects of the window assemblies described in U.S. Pat. Nos. 11,331,984; 10,501,977; 8,938,914; 8,915,018; 8,881,458; 8,402,695; 8,322,073; 7,838,115; 7,332,225; 7,073,293; 7,003,916; 6,846,039; 6,691,464; 6,319,344; 6,068,719; 5,853,895 and/or 5,799,444, and/or U.S. Publication Nos. US-2021-0355737; US-2014-0047772; US-2013-0174488; US-2011-0056140; US-2006-0107600; US-2008-0127563; US-2004-0020131 and/or US-2003-0213179, which are hereby incorporated herein by reference in their entireties. Although shown and described as a horizontally movable center window that moves relative to a pair of opposite side windows (such as for applications at the rear of a cab of a pickup truck or the like), it is envisioned that aspects described herein are applicable to other types of movable window assemblies, such as horizontally movable window panels that move relative to a single fixed window panel and/or frames (such as for a rear or side opening of a vehicle or the like), and/or such as vertically movable window panels that move relative to one or more fixed panels and/or frames (such as for a rear or side opening of a vehicle or the like).

Changes and modifications to the specifically described embodiments may be carried out without departing from the principles of the present invention, which is intended to be limited only by the scope of the appended claims, as interpreted according to the principles of patent law.

1. A vehicular rear slider window assembly, the vehicular rear slider window assembly comprising:
a fixed window panel;
a movable window panel;
an upper rail and a lower rail attached to the fixed window panel;
wherein the movable window panel is movable along the upper rail and the lower rail between (i) a closed position where the movable window panel is disposed at an opening of the fixed window panel and (ii) an opened position where the movable window panel is disposed at least partially along the fixed window panel;
wherein the upper rail comprises (i) a base portion attached to the fixed window panel and having a first engaging element and (ii) a cover portion attached to the base portion and having a second engaging element;
wherein, with the second engaging element of the cover portion engaged with the first engaging element of the base portion, the cover portion is at least partially secured relative to the base portion and the fixed window panel;
wherein, with the cover portion at least partially secured relative to the base portion and the fixed window panel, an attachment element is disposed at the upper rail to further secure the cover portion relative to the base portion; and
wherein a channel of the upper rail is disposed between the base portion and the cover portion of the upper rail, and wherein the channel receives an upper perimeter edge portion of the movable window panel.

2. The vehicular rear slider window assembly of claim 1, wherein the first engaging element comprises a receiving portion at the base portion, and wherein the second engaging element comprises a protrusion at the cover portion, and wherein the protrusion at the cover portion is at least partially received within the receiving portion at the base portion to at least partially secure the cover portion relative to the base portion and the fixed window panel.

3. The vehicular rear slider window assembly of claim 1, wherein the first engaging element comprises a protrusion at the base portion, and wherein the second engaging element comprises a receiving portion at the cover portion, and wherein the protrusion at the base portion is at least partially received within the receiving portion at the cover portion to at least partially secure the cover portion relative to the base portion and the fixed window panel.

4. The vehicular rear slider window assembly of claim 3, wherein the protrusion extends from a flange of the base portion, and wherein the receiving portion is formed at a leg of the cover portion, and wherein a hook extends from the base portion and spaced from the flange, and wherein, with the protrusion at the base portion at least partially received within the receiving portion at the cover portion, an end region of the leg of the cover portion is disposed between the flange of the base portion and the hook of the base portion to preclude the protrusion from pulling out of the receiving portion.

5. The vehicular rear slider window assembly of claim 1, wherein the attachment element comprises a threaded fastener.

6. The vehicular rear slider window assembly of claim 1, wherein a filler element is disposed within the channel of the upper rail, and wherein the filler element receives the upper perimeter edge portion of the movable window panel.

7. The vehicular rear slider window assembly of claim 6, wherein the filler element is attached to the cover portion of the upper rail.

8. The vehicular rear slider window assembly of claim 1, wherein the movable window panel is manually movable between the closed position and the opened position.

9. The vehicular rear slider window assembly of claim 1, wherein a drive system is electrically operable to move the movable window panel between the closed position and the opened position.

10. The vehicular rear slider window assembly of claim 1, wherein the fixed window panel comprises a single glass panel having the opening therethrough.

11. The vehicular rear slider window assembly of claim 1, wherein the fixed window panel comprises two fixed glass panels with the opening between the two fixed glass panels.

12. The vehicular rear slider window assembly of claim 1, wherein the vehicular rear slider window assembly is configured to be disposed at a rear portion of a cabin of a pickup truck.

13. A method of assembling a vehicular rear slider window assembly, the method comprising:
providing a fixed window panel comprising an opening;
attaching an upper rail to the fixed window panel;
attaching a lower rail to the fixed window panel;
positioning an upper perimeter edge portion of a movable window panel within a channel of the upper rail;
positioning a lower perimeter edge portion of the movable window panel within a channel of the lower rail;
wherein, with the movable window panel positioned within the channel of the upper rail and the channel of the lower rail, the movable window panel is movable along the upper rail and the lower rail between (i) a closed position where the movable window panel is disposed at the opening of the fixed window panel and (ii) an opened position where the movable window panel is disposed at least partially along the fixed window panel;
wherein attaching the upper rail to the fixed window panel comprises (i) attaching a base portion of the upper rail to the fixed window panel, (ii) partially securing a cover portion to the base portion so that a first engaging element of the base portion engages a second engaging element of the cover portion, (iii) engaging an attachment element with the base portion and the cover portion to further secure the cover portion relative to the base portion; and
wherein the channel of the upper rail is disposed between the base portion and the cover portion of the upper rail.

14. The method of claim 13, wherein the first engaging element comprises a receiving portion at the base portion, and wherein the second engaging element comprises a protrusion at the cover portion, and wherein the protrusion at the cover portion is at least partially received within the receiving portion at the base portion to partially secure the cover portion relative to the base portion.

15. The method of claim 13, wherein the first engaging element comprises a protrusion at the base portion, and wherein the second engaging element comprises a receiving portion at the cover portion, and wherein the protrusion at the base portion is at least partially received within the receiving portion at the cover portion to partially secure the cover portion relative to the base portion.

16. The method of claim 15, wherein the protrusion extends from a flange of the base portion, and wherein the receiving portion is formed at a leg of the cover portion, and wherein a hook extends from the base portion and spaced from the flange, and wherein, with the protrusion at the base portion at least partially received within the receiving portion at the cover portion, an end region of the leg of the cover portion is disposed between the flange of the base portion and the hook of the base portion to preclude the protrusion from pulling out of the receiving portion.

17. The method of claim 13, wherein the attachment element comprises a threaded fastener.

18. The method of claim 13, further comprising adhesively attaching a filler element to the cover portion so that, with the cover portion secured to the base portion, the filler element is disposed within the channel of the upper rail, and wherein the filler element receives the upper perimeter edge portion of the movable window panel.

19. The method of claim 13, wherein positioning the upper perimeter edge portion of the movable window panel within the channel of the upper rail occurs after partially securing the cover portion to the base portion and prior to engaging the attachment element with the base portion and the cover portion.

20. The method of claim 13, wherein the vehicular rear slider window assembly is configured to be disposed at a rear portion of a cabin of a pickup truck.
